(19) United States
(12) Patent Application Publication
(10) Pub. No.: US 2018/0367785 A1
(43) Pub. Date: Dec. 20, 2018

(54) removable accessory for a reception support such as a drone and an assembly comprising the reception support and the accessory

(71) Applicant: PARROT DRONES, Paris (FR)

(72) Inventors: Thierry Sanlaville, Paris (FR); Charles-Edouard Boucart, Paris (FR); Nicolas Texier, Paris (FR); Axel Balley, Paris (FR)

(21) Appl. No.: 16/006,260

(22) Filed: Jun. 12, 2018

(30) Foreign Application Priority Data
Jun. 14, 2017 (FR) 17 55365

(51) Int. Cl. H04N 13/246; H04N 7/18; H04N 5/225; H04N 5/232; B64C 39/02

(52) U.S. Cl. CPC H04N 13/246; H04N 7/181; B64C 2201/127; H04N 5/23238; B64C 39/024; H04N 5/2252

(57) ABSTRACT

The accessory includes a coupling part configured for the removable coupling of the accessory on the reception support, a connector configured for the electrical connection of the accessory to the reception support, and at least one sensor configured to generate an output signal representative of a physical property. The connector is directly connected at the output of the sensor to transmit the output signal from the sensor to the reception support without processing of the output signal between the sensor and the reception support.

This application claims priority from French Patent Application No. 17 55365 filed on Jun. 14, 2017. The content of this application is incorporated herein by reference in its entirety.

### FIELD

The present invention relates to the field of removable accessories for reception supports, such as a portable support or an unmanned vehicle, in particular a drone, i.e., an aircraft with no pilot on board.

### BACKGROUND

US2016/0083110A1 discloses a drone equipped with a nacelle able to be mounted removably on the drone and suitable for receiving a camera for capturing images during the flight of the drone. The nacelle able to be mounted removably makes it possible to equip the drone with the camera to capture images during the flight of the drone, and to disassemble the nacelle to remove the camera from the drone after the images are captured.

Mounting a camera on a drone increases the total loaded mass of the drone, which may affect the performance of the drone in flight, in particular its flight dynamics or its flight autonomy.

### SUMMARY OF THE INVENTION

One aim of the invention is to propose an accessory for a reception support, such as a portable support or an unmanned vehicle, in particular a drone, that can capture data while preserving the performance of the reception support.

To that end, the invention proposes a removable accessory for a reception support, such as a portable support or an unmanned vehicle, in particular a drone, the accessory comprising a coupling part configured for the removable coupling of the accessory on the reception support, a connector configured for the electrical connection of the accessory to the reception support, and at least one sensor configured to generate an output signal representative of a physical property, in which the connector is directly connected at the output of the sensor to transmit the output signal from the sensor to the reception support without processing of the output signal between the sensor and the reception support.

According to specific embodiments, the accessory may comprise one or several of the following optional features, considered alone or according to all technically possible combinations:
the sensor is an electronic component comprising a single electronic component housing;
the electronic component housing is of the surface-mounted component type;
the sensor is connected directly at the input to the connector for receiving control signals of the sensor;
it comprises a memory connected directly to the connector for addressing of the memory by a computer of the reception support;
at least one said sensor is an image sensor.
the connector is configured to connect to a corresponding connector of the reception support due to the fastening of the coupling part of the accessory on a corresponding coupling part of the reception support;
it has no processing unit of the signal to process the output signal of the sensor between the output of the sensor and the connector.

The invention also relates to an assembly comprising a reception support such as a portable support or an unmanned vehicle, in particular a drone, and an accessory as defined above, the reception support comprising a coupling part configured to cooperate with that of the accessory, a connector configured to engage with that of the accessory, and a computer configured to receive and process the output signal of each sensor.

According to specific embodiments, the assembly may comprise one or several of the following optional features, considered alone or according to all technically possible combinations:
the accessory comprises at least one image sensor, the computer being configured to implement at least one image processing algorithm chosen from among the following: auto-exposure correction, white balance correction, vignetting correction, color correction, defective pixel correction, spatial denoising, temporal denoising, contrast correction and/or optical distortion correction.
the accessory comprises at least two image sensors, the computer being configured to implement at least one image processing algorithm chosen from among the following: spatial alignment of images taken by the sensors such that the edges of the images coincide, combinations of images provided by the sensors to form an assembled image larger than the image provided by each sensor, for example a panoramic image larger than each image provided by each sensor, in particular an image with 360° vision, spatial calibration of the images taken by the different sensors and/or combinations of the images taken by sensors arranged for a stereovision image sensor, to form a three-dimensional image from images provided by the sensors; and
the computer is configured to address the memory of the accessory directly.

### BRIEF DESCRIPTION OF THE DRAWINGS

The invention and its advantages will be better understood upon reading the following description, provided solely as a non-limiting example, and done in reference to the appended drawings, in which:

FIG. 1 is a perspective view illustrating an assembly formed by a reception support in the form of a drone and an accessory able to be mounted removably on the reception support;

FIG. 2 is a detailed perspective view of the reception support and the accessory, illustrating a system for fastening the accessory on the reception support;

FIG. 3 is a block diagram illustrating the assembly of FIG. 1;

FIG. 4 is a perspective view of an assembly comprising the reception support of FIG. 1 and another accessory; and

FIG. 5 is a side view of an assembly comprising a reception support in the form of a handle and the accessory of FIGS. 1 and 2.

### DETAILED DESCRIPTION

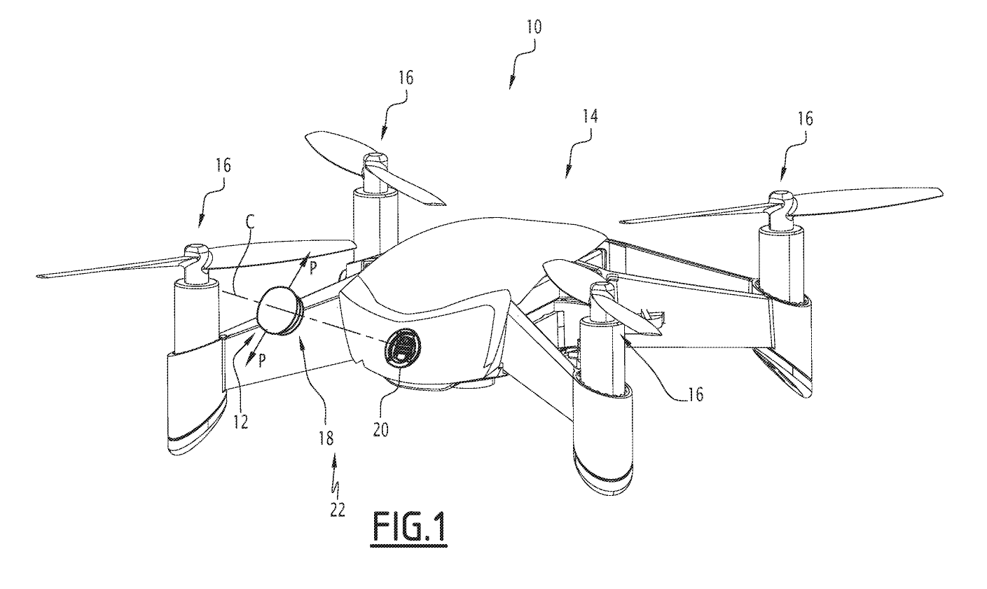

The assembly 10 illustrated in FIG. 1 comprises an accessory 12 able to be mounted removably on a reception support 14.

The reception support 14 here is a rotary-wing drone, i.e., an aircraft with no pilot on board, including at least one rotor 16 (or propeller) actuated by at least one motor. In FIG. 1, the drone includes a plurality of rotors 16, and is then called multi-rotor drone. The number of rotors 16 is in particular equal to four in this example, and the drone is then a quadrirotor drone or “quadcopter”. Alternatively, the drone for example comprises six rotors or eight rotors. In one alternative, the drone is a fixed-wing drone.

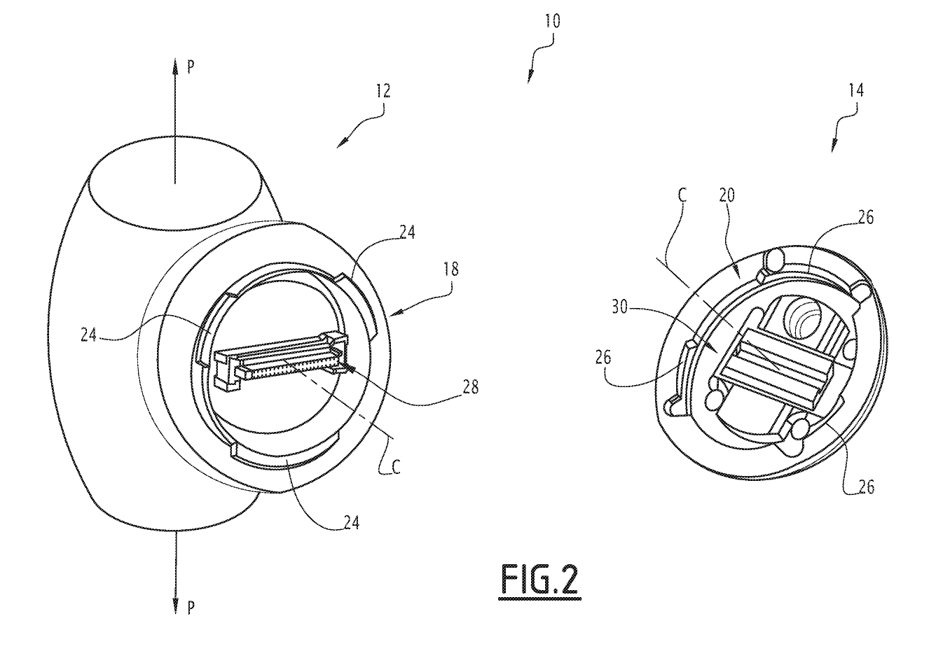

As shown in FIG. 2, the accessory 12 and the reception support 14 each have a respective coupling part 18, 20, the coupling parts 18, 20 being configured to cooperate with one another for the mechanical coupling of the accessory 12 and the reception support 14. The coupling parts 18, 20 together form a coupling mechanism 22.

The coupling mechanism 22 is for example a coupling mechanism with quick assembly and quick disassembly. This makes the coupling and uncoupling of the accessory 12 and the reception support 14 easier.

In the illustrated example, the coupling mechanism 22 is of the bayonet type. The coupling of the accessory 12 to the reception support 14 requires engaging the coupling parts 18, 20 with one another along a coupling axis C, then pivoting the coupling parts 18, 20 relative to one another around the coupling axis C to lock the coupling mechanism 22.

To that end, for example, one of the coupling parts 18, 20 comprises at least one lug 24, and the other comprises at least one groove 26, each groove 26 being able to receive an associated lug 24, each groove 26 comprising an engagement segment extending axially along the coupling axis C extended by a locking segment extending circumferentially around the coupling axis C.

In the illustrated example, lugs 24 are provided on the coupling part 18 of the accessory 12 and grooves 26 are provided on the coupling part 20 of the reception support 14. In one alternative, the arrangement of the lugs 24 and the grooves 26 is reversed.

The accessory 12 and the reception support 14 each comprise a respective connector 28, 30, the connectors 28, 30 being configured to engage with one another for the electrical connection of the accessory 12 with the reception support 14. The connectors 28, 30 each include a plurality of electrical contacts.

The connectors 28, 30 here are arranged so as to engage due to the coupling of the accessory 12 on the reception support 14. More specifically, the connectors 28, 30 are arranged so as to engage due to the union of the coupling parts 18, 20.

In the illustrated example, the connectors 28, 30 are arranged so as to engage in one another along the coupling axis C due to the union of the coupling parts 18, 20.

As illustrated, the coupling parts 18, 20 assume the form of rings, each connector 28, 30 being arranged inside the corresponding coupling part 18, 20.

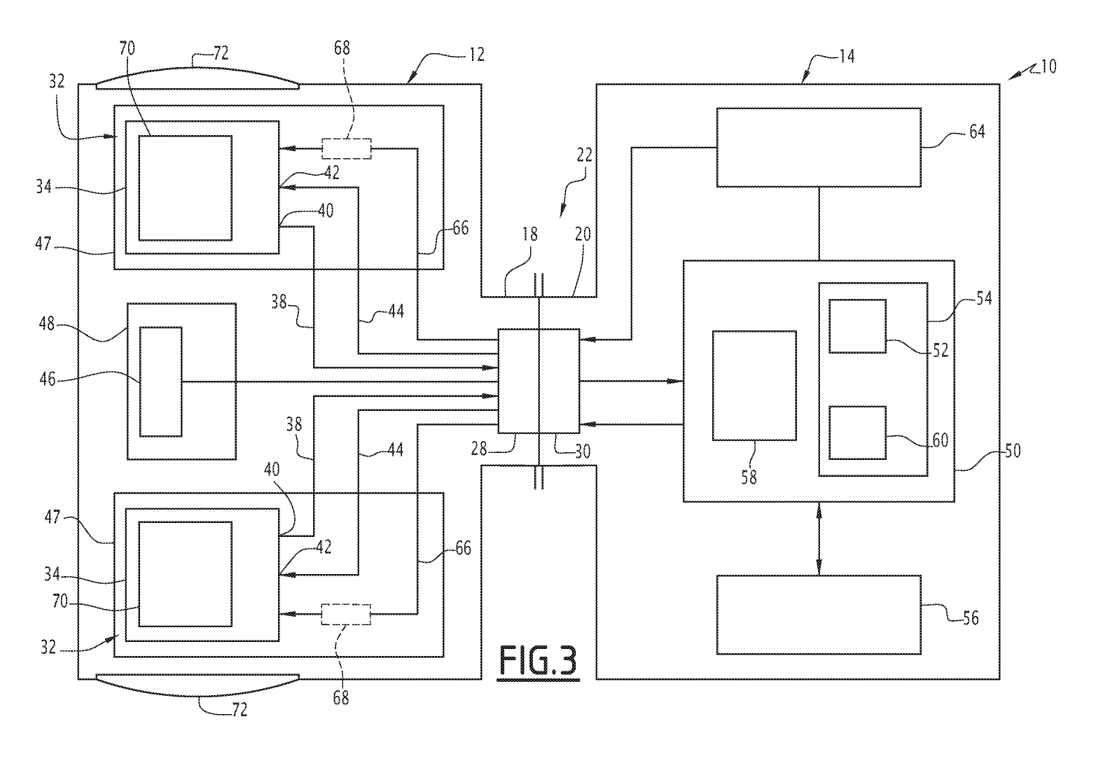

As illustrated in FIG. 3, the accessory 12 comprises at least one sensor 32 configured to generate an output signal representative of a physical property measured by the sensor 32.

In the illustrated example, the accessory 12 comprises two separate sensors 32. Alternatively, the accessory 12 comprises a single sensor or more than two sensors.

Each sensor 32 assumes the form of an electronic component comprising a single electronic component housing 34. Each sensor 32 is for example of the surface-mounted component (or SMC) type. Such a component is provided to be applied on a surface, in particular a surface of a printed circuit.

The connector 28 of the accessory 12 is connected directly at the output of each sensor 32. The output signal of each sensor 32 is sent directly to the connector 28 of the accessory 12 without processing of the output signal [of] the sensor 32 and the connector 28 of the accessory 12.

The connector 28 of the accessory 12 is connected to the output 40 of each sensor 32, delivering the output signal of this sensor 32, by an output communication bus 38 extending between the output 40 of the sensor 32 and the connector 28 of the accessory 12.

Each sensor 32 comprises at least one input 42 connected directly to the connector 28 of the accessory 12 for receiving input signals. Input signals are received directly by each sensor 32 coming from the connector 28 of the accessory 12 without processing between the connector 28 of the accessory 12 and the sensor 32.

The connector 28 of the accessory 12 is connected directly to the input 42 of each sensor 32 by an input communication bus 44 extending between the input of the sensor 32 and the accessory connector 28.

Input signals of each sensor 32 are for example control signals of the sensor 32.

Preferably, the accessory 12 further comprises a housing, the coupling part of the accessory 12, the connector 28 and each sensor 32 being fastened on the housing and/or received in the housing.

Optionally, the accessory 12 comprises a memory 46 connected directly to the connector 28 of the accessory 12. Here, the accessory 12 comprises a communication bus 48 directly connecting the memory 46 to the connector 28 of the accessory 12.

The memory 46 contains identification data of the accessory 12 and/or configuration data of the accessory 12.

The memory 46 connected directly to the connector 28 of the accessory 12 is addressable (i.e., testable) directly by a computer of the reception support 14 connected to the accessory 12 via the connector 28 of the accessory 12.

The memory 46 is for example a read-only memory, in particular an erasable and programmable random-access memory (EPROM).

The memory 46 is preferably provided in the form of an electronic component comprising a single electronic component housing.

In the illustrated example, the accessory 12 comprises a respective printed circuit 47 for each sensor 32. It further comprises a printed circuit 48 on which the accessory memory 46 is fastened. Alternatively, the accessory 12 comprises a single printed circuit on which each sensor 32 is fastened. The memory 46 is preferably also fastened on this single printed circuit.

The reception support 14 comprises a computer 50 connected to the connector 20 of the reception support 14. When the accessory 12 is connected to the reception support 14, the computer 50 is connected to each sensor 32, via connectors 28, 30 engaged with one another.

The computer 50 receives the output signal of each sensor 32 without processing of the output signal of the sensor 32 between the output 40 of the sensor 32 located in the accessory 12 and the computer 50 located in the reception support 14.

The computer 50 comprises at least one processing module 52, each processing module 52 being configured to process the output signal of at least one sensor 32, received by the computer 50.

The computer 50 for example comprises at least one processing module 52 configured to store the output signal in a memory 54 of the computer 50, for example for subsequent recovery thereof by the user.

Alternatively or optionally, the computer 50 comprises at least one processing module 52 configured to send the output signal to another electronic device separate from the reception support 14, via a communication device 56 integrated into the reception support 14.

The communication device 56 is for example a radio communication device for exchanging remote wireless signals with a remote electronic system, for example an electronic system for guiding the reception support 14 provided in the form of a drone.

Alternatively or optionally, the computer 50 comprises at least one processing module 52 configured to implement an algorithm for processing the output signal of at least one sensor 32 in order to correct, improve and/or convert the output signal, for example by combining the output signals of several sensors 32 of the accessory 12.

In the illustrated example, the computer 50 comprises the memory 54 and a processor 58.

Each processing module 52 is provided in the form of a computer program stored in the memory 54 of the computer 50 and comprising code instructions executable by the processor 58 of the computer 50.

Alternatively, at least one processing module 52 is provided in the form a dedicated integrated circuit or ASIC (Application-Specific Integrated Circuit) or a programmable logic component, for example an FPGA (Field Programmable Gate Array), configured or programmed to process at least one output signal from a sensor 32 of the accessory 12.

In one example embodiment, the computer 50 comprises at least one computer driver 60 configured to control at least one sensor 32 of an accessory 12 able to be coupled to the reception support 14.

In one embodiment, each computer driver 60 is a computer program stored in the memory 54 of the computer 50 and executable by the processor 58 to control a sensor 32 of the accessory 12. Each computer driver 60 is associated with a specific sensor 32.

When the accessory 12 is connected to the reception support 14, the control instructions generated by a computer driver 60 of the computer 50 for controlling a sensor 32 of the accessory 12 are sent to an input 42 of this sensor 32 via the input communication bus 44.

Advantageously, the computer 50 comprises several computer drivers 60 stored in its memory 54, each computer driver 60 being configured to control a determined sensor 32, the computer 50 being configured to open at least one computer driver 60 necessary to control each sensor 32 of the accessory 12 from a memory 54 of the computer 50 containing computer drivers 60, based on identification data and/or configuration data contained in the memory 46 of the accessory 12 coupled to the reception support 14.

When the accessory 12 is connected to the reception support 14, the computer 50 is connected to the memory 46 of the accessory 12.

The computer 50 can address (i.e., query) the memory 46 of the accessory 12 directly to identify the accessory 12 and/or to determine the configuration of the accessory 12, and to load the computer driver(s) 60 necessary to control each sensor 32 of the accessory 12.

Preferably, the computer 50 is configured to command the reception support 14.

In the illustrated example, in which the reception support 14 is a drone, the computer 50 is for example configured to control the drone.

The computer 50 for example comprises an automatic pilot able to provide piloting assistance, the computer 50 receiving piloting instructions entered by a user using a remote electronic guiding system, and/or autonomous automatic piloting, the computer 50 piloting the drone autonomously, according to at least one defined autonomous piloting mode, for example target tracking, trajectory tracking, path tracking with one or several mandatory waypoints.

Piloting instructions from a remote electronic guiding system are for example received via the communication device 56.

Preferably, the accessory 12 is supplied with energy by the reception support 14. More specifically, the reception support 14 incorporates a power source 64, for example an electric battery, the accessory 12 being supplied with energy by the power source 64 when the accessory 12 is connected to the reception support 14.

The connectors 28, 30 are configured to transmit energy between the reception support 14 and the accessory 12.

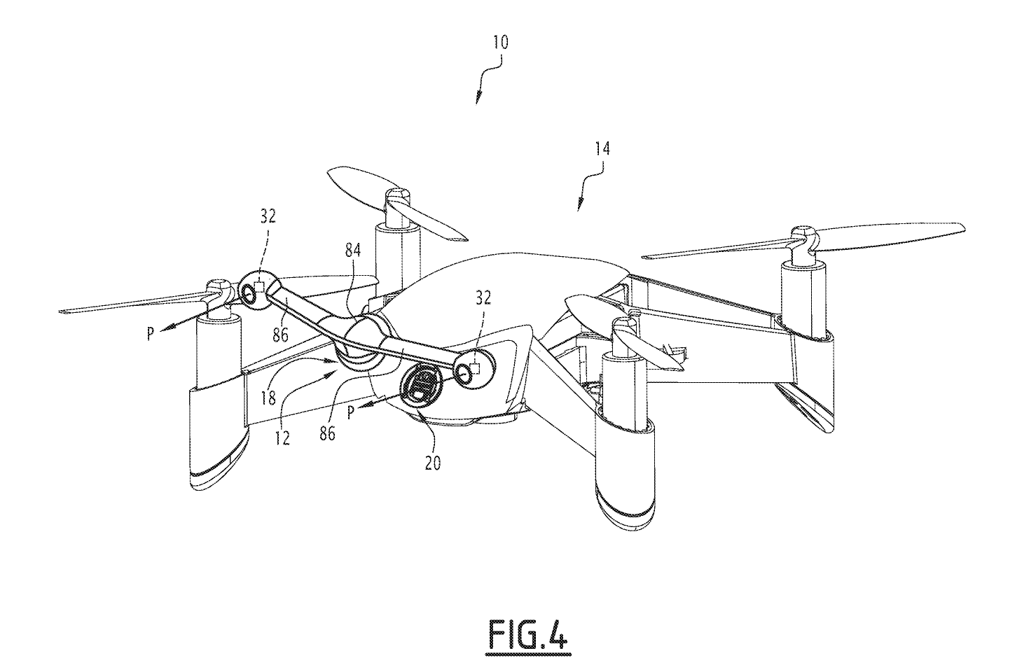

As illustrated in FIG. 4, the accessory 12 comprises a power supply bus 66 connecting each sensor 32 to the accessory connector 18 to supply power to the sensor 32.

Each power supply bus 66 associated with a sensor 32 extends between the connector 28 and at least one power supply input of this sensor 32.

In one embodiment, the power supply bus 66 associated with at least one of the sensors 32 or each sensor 32 directly connects the connector 28 to a power supply input of this sensor 32.

Alternatively, the accessory 12 comprises a filtering circuit 68 arranged upstream from at least one power supply input of at least one of the sensors 32 or each of the sensors 32, for filtering the power supply. Each filtering circuit 68 for example comprises one or several passive electrical component(s).

In the illustrated embodiment, the accessory 12 comprises two sensors 32 that are image sensors. Each sensor 32 delivers a digital output signal representative of an image.

The accessory 12 comprises an optical objective 72 associated with each sensor 32, each optical objective 72 being arranged such that the light reaches the associated sensor 32 through the optical objective 72.

The output signal of each sensor 32 is sent from the output of the sensor 32 to the connector 28 of the accessory 12 without processing of the output signal between the output 40 of the sensor 32 and the connector 28. The output 40 of the sensor 32 delivering the output signal representative of images captured by the sensor 32 is connected directly to the connector 28 of the accessory 12.

Each sensor 32 is an electronic component comprising a single electronic component housing 34, having an output 40 delivering the output signal representative of an image.

Each sensor 32 comprises a matrix photodetector 70 able to detect photons, and delivers an output signal corresponding to the photons detected by the photodetector 70.

Each sensor 32 for example delivers an output signal in a RAW format.

The computer 50 integrated into the reception support 14 comprises the or each computer driver 60 necessary to control each sensor 32 directly via the computer 50. Upon connecting the accessory 12 to the reception support 14, the computer 50 opens the appropriate computer drivers 60.

The computer 50 for example comprises at least one processing module 52 configured to apply at least one image processing algorithm to the output signal of each sensor 32.

The computer 50 is configured to apply at least one image processing algorithm intended to correct an image and/or to improve an image, for example at least one image processing algorithm chosen from among the following:
auto-exposure correction;
white balance correction;
vignetting correction;
color correction;
defective pixel correction;
spatial denoising;
temporal denoising;
contrast correction; and/or
optical distortion correction.

In one embodiment, the computer 50 is configured to apply each of these image processing algorithms to the output signal of each sensor 32.

When the accessory 12 comprises at least two separate image sensors 32, advantageously, the computer 50 is configured to implement at least one image processing algorithm configured to combine respective images provided by the sensors 32.

The computer 50 is for example configured to implement at least one image processing algorithm configured to compute panoramic view or 360° images from output signals provided by the sensors 32, by combining the images provided by the sensors 32 in order to form an assembled image larger than the elementary image provided by each sensor 32.

The computer 50 is for example configured to implement one or several of the following image processing algorithms:
spatial alignment of the images taken by the different sensors 32 such that the edges of the images coincide; and/or
combination of the elementary images provided by the sensors 32 to form an assembled image larger than the elementary image provided by each sensor 32, for example an assembled image larger than the elementary image provided by each sensor 32, in particular a 360° view image.

In the illustrated example, the accessory 12 comprises two sensors 32, the sensors 32 and/or the associated optical objectives 72 being arranged such that the viewing axes of the two sensors 32 are substantially coaxial, the sensors 32 targeting opposite directions.

Alternatively, it is possible to provide more than two sensors 32 to provide a panoramic or 360° view image, for example at least three sensors 32 sighting in several separate directions that are substantially radial relative to a center.

The accessory of FIG. 4 differs from that of FIG. 1 in that it comprises two separate image sensors 32 arranged to capture images of a scene in stereovision. The image sensors 32 provide images of the same scene, the images being spatially offset.

The capture of images of a scene in stereovision for example makes it possible to calculate a three-dimensional (3D) reconstruction of the scene and/or to calculate 3D images from images of the sensors 32.

As illustrated in FIG. 4, the accessory 12 comprises a base 84 supporting the coupling part 18 of the accessory 12 and two arms 86 extending from the base 84, each arm 86 supporting a respective sensor 32 at its end opposite the base 84.

Here, the arms 84 are collinear and extend opposite one another from the base. Alternatively, the arms 84 are not collinear.

The sighting axes P of two sensors 32 are substantially parallel and separate. The center distance between the sighting axes of the two sensors 32 is non-nil. It is for example comprised between 1 and 30 cm. The captured images

The computer 50 is for example configured to implement one or several of the following image processing algorithms:
spatial calibration of the images taken by the different sensors 32; and/or
combinations of the images provided by the sensors 32 in order to form a three-dimensional image from images provided by the sensors 32.

In the examples of FIGS. 1 to 4, the accessories 12 have two image sensors 32.

Alternatively, it is possible to provide an accessory comprising a single image sensor.

In the case of a reception support 14 in the form of an unmanned vehicle, such as a drone, provided with an accessory having at least one image sensor, the processing and sending of images directly to a remote electronic guiding system provided with an image viewing device allows a user to view the images directly that are taken by the accessory 12.

In one particular example in which the electronic guiding system allows first-person view (FPV) control, the computer can process the signals provided by two image sensors 32 of the accessory 12 to reconstitute a 360° image or a 3D image and send it to the remote electronic guiding system via a communication device 56 on board the driverless vehicle.

In the case of a reception support 14 in the form of an unmanned vehicle, such as a drone, provided with an accessory 12 having at least one image sensor 32 for directly sending images to a remote electronic guiding system, preferably the processing of the output signal of each sensor 32 is done by the computer 50 of the reception support 14 to send a ready-to-display image signal to the remote electronic guiding system, without processing being needed within the remote electronic guiding system other than the processing to display the received images on a viewing device of the remote electronic guiding system, without correction, improvement or transformation of the received images.

During operation, the accessory 12 is initially separated or uncoupled from the reception support 14. The user couples the accessory 12 to the reception support 14 manually, and connects the accessory to the reception support. Advantageously, the connection is done due to the coupling.

The connection of the accessory 12 to the reception support 14 causes the connection of the computer 50 to the memory 46 of the accessory 12. The computer 50 directly addresses the memory 46 of the accessory 12 to recover identification data and/or configuration data stored in the memory 46 of the accessory 12.

The computer 50 determines, based on identification data, the type of the accessory 12, in particular the sensor(s) 32 present on the accessory 12. The computer 50 may for example determine whether the accessory 12 comprises one image sensor 32 or several image sensors 32. In the case of several image sensors 32, the computer 50 may for example determine whether the sensors 32 are arranged for a panoramic or 360° view or for an image capture in stereovision.

Depending on the version and/or the configuration of a sensor 32, the computer 50 loads one or several computer drivers 60 to control each sensor 32 and/or one or several processing modules 52 in order to process the output signal of each sensor 32. Each computer driver 60 and/or each necessary processing module 52 is for example loaded in a random access memory of the computer 50, for execution thereof.

For example, if the accessory 12 has two image sensors 32 arranged for a 360° vision, it is useful to load a processing module 52 configured to combine images to generate one large image from two small images taken by two separate image sensors, and it is not useful to load a processing module 52 configured to calculate images in 3D from images captured in stereovision.

Next, while the user uses the reception support 14 provided with the accessory 12, the computer 50 controls each sensor 32 of the accessory 12. The measuring signal of each sensor 32 of the accessory 12 is sent to the reception support 14 without being processed between the output 40 of the sensor 32 and the connector 28 of the accessory 12, and the computer 50 processes the output signal provided by the sensor 32 without processing this output signal between the output 40 of the sensor 32 and the connector 28 of the accessory 12.

No processing of the output signal of each sensor 32 is done in the accessory 12. The first processing of the output signal of each sensor 32 is done in the computer 50 of the reception support 14.

In the examples described above, the accessories 12 have image sensors 32. However, the invention is not limited to an accessory 12 provided with one or several image sensors 32.

Alternatively, it is possible to provide an accessory with at least one sensor 32 of a different type. Furthermore, an accessory may comprise one or several different sensors 32, of the same type or different types.

An accessory 12 may comprise one or several sensors for measuring physical properties, such as air temperature, air pressure, a temperature of a surface, a distance, sound, radiation (infrared, ultraviolet, alpha, beta and/or gamma), an orientation, acceleration, geographical position, etc.

Thus, in general, the accessory comprises one or several sensors 32 chosen from among: an image sensor, a temperature sensor, a pressure sensor, a sound sensor, a radiation sensor (infrared, ultraviolet, alpha, beta and/or gamma), a time of flight camera, an inertial unit, etc.

In all cases, the connector 28 of the accessory 12 being connected at the output of each sensor 32 in order to send the output signal of each sensor 32 to the reception support 14 receiving the accessory 12, without processing the output signal between the sensor 32 and the connector 28 of the accessory 12, and for processing of the output signal of the sensor 32 by the computer 50 of the reception support 14.

Preferably, each sensor 32 is an electronic component comprising a single electronic component housing 34 having an output delivering the output signal of the sensor 32 connected directly to the connector 28 of the accessory 12 by a communication bus.

Furthermore, the invention is not limited to a reception support in the form of a drone. It is possible to provide a reception support in the form of an unmanned vehicle of the remotely controlled car type.

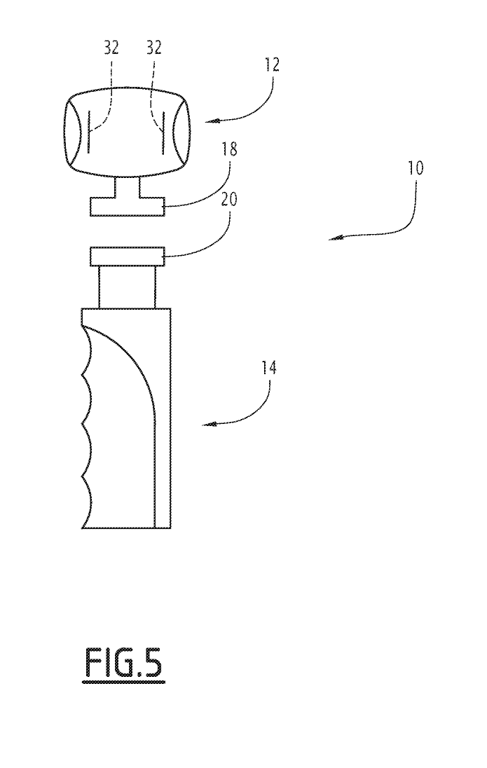

As illustrated in FIG. 5, it is also possible to provide a reception support 14 in the form of a manipulation handle on which the accessory 12 can be removably coupled.

The removable accessory 12 able to be mounted on a reception support 14 and provided with a sensor 32 while being provided without means for processing the output signal of the sensor between the output 40 of the sensor 32 and a connector 28 of the accessory 12 for its connection to the reception support 14 makes it possible to obtain a light and compact accessory 12.

This is an advantage for its coupling to an unmanned vehicle, in particular a drone. Indeed, due to its lightness and compactness, the accessory has a reduced impact on the performance of the driverless vehicle, and in particular its energy autonomy.

This is also advantageous in the case of a portable reception support, since this preserves the lightness of the portable reception support 14, which facilitates its manipulation by the user.

The reception support 14 configured to process the signal from the sensor using a computer 50 integrated into the reception support 41 makes it possible to provide processing of the output signal of the sensor 32 within the assembly formed by the accessory 12 and the reception support 14, so as to obtain a processed signal that can for example be sent to a remote electronic system or stored in a memory of the computer 50 and recovered later.

It is possible to configure the computer 50 of the reception support 14 to allow the coupling of several accessories 12 having different types of sensors or combinations of sensors including different sensors.

Thus, it is possible to provide a range of different accessories 12 able to be coupled to the same reception support 14, the reception support 14 being configured to detect the type of accessory 12 coupled to the reception support 14 and to process the output signal of each sensor 32 of the accessory 12 based on the type of accessory 12 coupled to the reception support 14.

Likewise, it is possible to provide several reception supports 14 of different types, able to receive a same accessory 12.

It is for example possible to provide a portable support and an unmanned vehicle, each able to receive a same accessory 12 and to process the output signal of each sensor 32 of this accessory 12.

1. A removable accessory for a reception support, the accessory comprising a coupling part configured for the removable coupling of the accessory on the reception support, a connector configured for the electrical connection of the accessory to the reception support, and at least one sensor configured to generate an output signal representative of a physical property, wherein the connector is directly connected at the output of the sensor to transmit the output signal from the sensor to the reception support without processing of the output signal between the sensor and the reception support.

2. The accessory according to claim 1, wherein the sensor is an electronic component comprising a single electronic component housing.

3. The accessory according to claim 2, wherein the electronic component housing is of the surface-mounted component type.

4. The accessory according to claim 1, wherein the sensor is connected directly at the input to the connector for receiving control signals of the sensor.

5. The accessory according to claim 1, comprising a memory connected directly to the connector for addressing of the memory by a computer of the reception support.

6. The accessory according to claim 1, wherein at least one said sensor is an image sensor.

7. The accessory according to claim 1, wherein the connector is configured to connect to a corresponding connector of the reception support due to the fastening of the coupling part of the accessory on a corresponding coupling part of the reception support.

8. The accessory according to claim 1, with no processing unit of the signal to process the output signal of the sensor between the output of the sensor and the connector.

9. An assembly comprising a reception support and an accessory according to claim 1, the reception support comprising a coupling part configured to cooperate with that of the accessory, a connector configured to engage with that of the accessory, and a computer configured to receive and process the output signal of each sensor.

10. The assembly according to claim 9, wherein the accessory comprises at least one image sensor, the computer being configured to implement at least one image processing algorithm chosen from among the following:
auto-exposure correction;
white balance correction;
vignetting correction;
color correction;
defective pixel correction;
spatial denoising;
temporal denoising;
contrast correction; and/or
optical distortion correction.

11. The assembly according to claim 9, wherein the accessory comprises at least two image sensors, the computer being configured to implement at least one image processing algorithm chosen from among the following:
spatial alignment of images taken by the sensors such that the edges of the images coincide;
combinations of images provided by the sensors to form an assembled image larger than the image provided by each sensor, for example a panoramic image larger than each image provided by each sensor, in particular an image with 360° vision;
spatial calibration of the images taken by the different sensors; and/or
combinations of the images taken by sensors arranged for a stereovision image capture, to form a three-dimensional image (3D) from images provided by the sensors.

12. The assembly according to claim 10, the accessory comprising a memory connected directly to the connector, the computer being configured to address the memory of the accessory directly.

13. The accessory according to claim 1, wherein the reception support is a portable support or an unmanned vehicle.

14. The accessory according to claim 13, wherein the unmanned vehicle is a drone.

15. The assembly according to claim 9, wherein the reception support is a portable support or an unmanned vehicle.

16. The assembly according to claim 15, wherein the unmanned vehicle is a drone.
